(19) United States
(12) Patent Application Publication
(10) Pub. No.: US 2015/0067483 A1
(43) Pub. Date: Mar. 5, 2015

(54) ELECTRONIC DEVICE AND METHOD FOR DISPLAYING ELECTRONIC DOCUMENT

(71) Applicant: Kabushiki Kaisha Toshiba, Tokyo (JP)

(72) Inventors: Takehiko Demiya, Mitaka-shi (JP); Eita Shuto, Tokyo (JP)

(73) Assignee: Kabushiki Kaisha Toshiba, Tokyo (JP)

(21) Appl. No.: 14/257,580

(22) Filed: Apr. 21, 2014

(30) Foreign Application Priority Data
Aug. 30, 2013 (JP) 2013-179643

(51) Int. Cl. G06F 17/21

(52) U.S. Cl. CPC G06F 17/211
USPC 715/249

(57) ABSTRACT

According to one embodiment, an electronic device displays an electronic document in a first style. The document includes a handwritten stroke associated with a first element in the document. The handwritten stroke is displayed in a first area in the document of the first style. A relative position of the first area with respect to the first element is a first relative position. The device displays the document in a second style different and changes a display position of the handwritten stroke from the first area to a second area in the document of the second style. A relative position of the second area with respect to the first element in the document of the second style is a second relative position different from the first relative position.

### CROSS-REFERENCE TO RELATED APPLICATIONS

This application is based upon and claims the benefit of priority from Japanese Patent Application No. 2013-179643, filed Aug. 30, 2013, the entire contents of which are incorporated herein by reference.

### FIELD

Embodiments described herein relate generally to a technology of processing an electronic document including a handwritten stroke.

### BACKGROUND

In recent years, various kinds of electronic devices, such as tablets, PDAs, and smartphones, have been developed. These kinds of electronic devices are widely used as a tool for viewing various electronic documents, for example, Web pages, electronic books, and documents in various other formats.

Of electronic documents, there are reflowable electronic documents. As regards reflowable electronic documents, a style to be displayed of the electronic document can be adjusted in accordance with a screen size, etc. For example, when a window size of viewing software is changed by a user, or when a display mode of an electronic device is switched between a landscape mode and a portrait mode, the electronic document which is being viewed is reflowed (rearranged) to adapt to the current screen size.

The aforementioned reflow function enables to enhance viewability of an electronic document.

However, when an electronic document including a handwritten stroke associated with a certain element in the electronic document is to be reflowed, if the handwritten stroke is simply moved in accordance with a newly moved (destination) position of that element, there are cases where the handwritten stroke overlaps another element in the electronic document and viewability of the electronic document is thereby adversely affected.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an outer appearance of an electronic device according to an embodiment;

FIG. 2 is an exemplary view illustrating a cooperative operation between the electronic device of the embodiment and an external device;

FIG. 3 is a view illustrating an example of an annotation to be directly handwritten on a Web page displayed on a touchscreen display of the electronic device of the embodiment;

FIG. 4 is a view illustrating an example of an annotation to be directly handwritten on an electronic book displayed on the touchscreen display of the electronic device of the embodiment;

FIG. 5 is a view illustrating an example of a handwritten object on the touchscreen display of the electronic device of the embodiment;

FIG. 6 is an exemplary view illustrating time-series information corresponding to the handwritten object of FIG. 5, which is stored on a storage medium by the electronic device of the embodiment;

FIG. 7 is an exemplary block diagram illustrating a system structure of the electronic device of the embodiment;

FIG. 8 is an exemplary block diagram illustrating a function structure of a browser application program executed by the electronic device of the embodiment;

FIG. 9 is an illustration for describing an example of a relationship between display positions of handwritten annotations on an electronic document before reflow and display positions of the handwritten annotations on the electronic document after reflow;

FIG. 10 is an illustration for describing a situation in which a part of the handwritten annotations passes out of view by a reflow of the electronic document;

FIG. 11 is an illustration for describing another example of a relationship between a display position of a handwritten annotation on an electronic document before reflow and a display position of the handwritten annotation on an electronic document after reflow; and

FIG. 12 is an exemplary flowchart illustrating a procedure of display processing executed by the electronic device of the embodiment.

### DETAILED DESCRIPTION

Various embodiments will be described hereinafter with reference to the accompanying drawings.

In general, according to one embodiment, an electronic device comprises a display processor and a processor. The display processor displays an electronic document in a first style. The electronic document includes a handwritten stroke associated with a first element in the electronic document, the handwritten stroke is displayed in a first area in the electronic document of the first style. The first area is in a first relative position with respect to the first element. The processor displays the electronic document in a second style different from the first style, and changes a display position of the handwritten stroke from the first area to a second area in the electronic document of the second style. Second relative position of the second area with respect to the first element in the electronic document of the second style is different from the first relative position of the first area with respect to the first element in the electronic document of the first style.

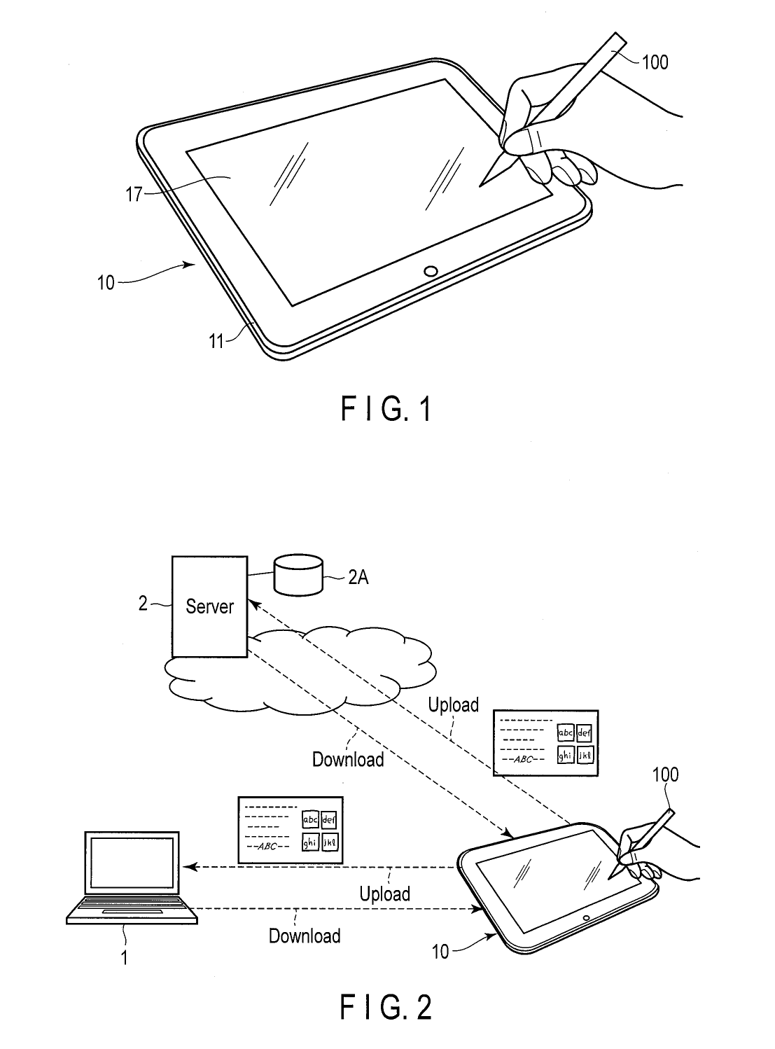

FIG. 1 is a perspective view illustrating an outer appearance of an electronic device according to an embodiment. The electronic device is a portable electronic device configured to input data by handwriting using a pen or a finger, for example. The electronic device may be realized as a tablet computer, a notebook personal computer, a smartphone, a PDA, etc. It is assumed that the electronic device is realized as a tablet computer 10. The tablet computer 10 is a portable electronic device which is also referred to as a tablet or a slate computer. The tablet computer 10 can function as a terminal for viewing various electronic documents (digital documents), for example, a Web page, an electronic book, and a document file of various other formats. The tablet computer 10 comprises a main body 11 and a touchscreen display 17, as shown in FIG. 1. The touchscreen display 17 is attached such that the touchscreen display 17 is laid over the top surface of the main body 11.

The main body 11 includes a thin box-like housing. In the touchscreen display 17, a flat-panel display and a sensor configured to detect a contact position of a pen or a finger on a screen of the flat-panel display are incorporated. The flat-panel display may be a liquid crystal display (LCD), for example. As the sensor, a capacitive touchpanel and an electromagnetic induction-type digitizer, for example, can be used. It is assumed that both of the two types of sensors, i.e., a digitizer and a touchpanel, are incorporated in the touchscreen display 17.

The touchscreen display 17 can detect not only a touch operation on a screen using a finger, but also a touch operation on the screen using a pen 100. The pen 100 may be a digitizer pen (electromagnetic induction pen), for example.

A user can perform a handwriting input operation on the touchscreen display 17 by using the pen 100. During the handwriting input operation, a locus (a path) of movement of the pen 100 on the screen, namely, a handwritten stroke (a locus of a handwritten stroke) is drawn in real time by the handwriting input operation, and a plurality of strokes input by handwriting are thereby displayed on the screen. The locus of movement of the pen 100 while the pen 100 is touching the screen corresponds to one stroke.

In the present embodiment, a handwritten object (for example, a handwritten character, handwritten graphics, a handwritten mark, etc.) can be directly added on an electronic document, such as a Web page, by a handwriting input operation. The handwritten object on the electronic document is used as an annotation (handwritten annotation).

That is, a Web browser application program installed in the tablet computer 10 comprises a handwriting engine. The handwriting engine comprises a drawing module configured to draw an object on the screen in accordance with an input by handwriting, and a gesture detector configured to detect various gestures on the screen that use a finger or the pen 100. During a handwriting input operation, a locus of movement of the pen 100 on the screen, namely, a handwritten stroke (a locus of a handwritten stroke) is directly drawn on a Web page in real time by the handwriting input operation, and a plurality of handwritten strokes (loci of handwritten strokes) input by handwriting are thereby displayed on the Web page as a handwritten annotation. With a Web browser application program, it is possible to view not only an electronic document (Web page) created by using a markup language, such as HTML, but also an electronic book in ePub format, etc. Further, with the Web browser application program, a handwritten annotation can be directly added to not only the Web page but also the electronic book in accordance with the handwriting input operation.

FIG. 2 illustrates an example of a cooperative operation between the tablet computer 10 and an external device. The tablet computer 10 can cooperate with a personal computer 1 or a cloud. That is, the tablet computer 10 comprises a wireless communication device, such as a wireless LAN, and can execute radio communication with the personal computer 1. Further, the tablet computer 10 can execute communication with a server 2 on the Internet. The server 2 may be a server which executes an online storage service and various other cloud computing services.

The personal computer 1 comprises a storage device, such as a hard disk drive (HDD). The tablet computer 10 transmits an electronic document including a handwritten annotation to the personal computer 1 over a network so that it can be stored (uploaded) on the HDD of the personal computer 1. Further, the tablet computer 10 can read (download) an electronic document including a handwritten annotation from the HDD of the personal computer 1 and have it displayed on the screen of the touchscreen display 17 of the tablet computer 10.

Further, a device with which the tablet computer 10 communicates may be the server 2 on the cloud which provides the storage service or the like, as stated above, instead of the personal computer 1. The tablet computer 10 transmits an electronic document including a handwritten annotation to the server 2 over the network so that it can be stored (uploaded) on a storage device 2A of the server 2. Further, the tablet computer 10 can read (download) an electronic document including a handwritten annotation from the storage device 2A of the server 2 and have it displayed on the screen of the touchscreen display 17 of the tablet computer 10.

As can be seen, in the present embodiment, a storage medium on which the electronic document including the handwritten annotation is stored may be any of the storage device of the tablet computer 10, the storage device of the personal computer 1, and the storage device of the server 2.

Normally, an electronic document includes a plurality of elements. A handwritten annotation is associated with an arbitrary element in the electronic document. If the electronic document is a Web page, the element with which the handwritten annotation is associated may be an arbitrary single element among a plurality of hierarchical elements included in the Web page. Alternatively, the associated element may be a part of the arbitrary element (for example, a character string). If the electronic document is an electronic book, the element with which the handwritten annotation is associated may be a text of an arbitrary paragraph in the electronic book or a part of the text of this arbitrary paragraph (for example, a character string).

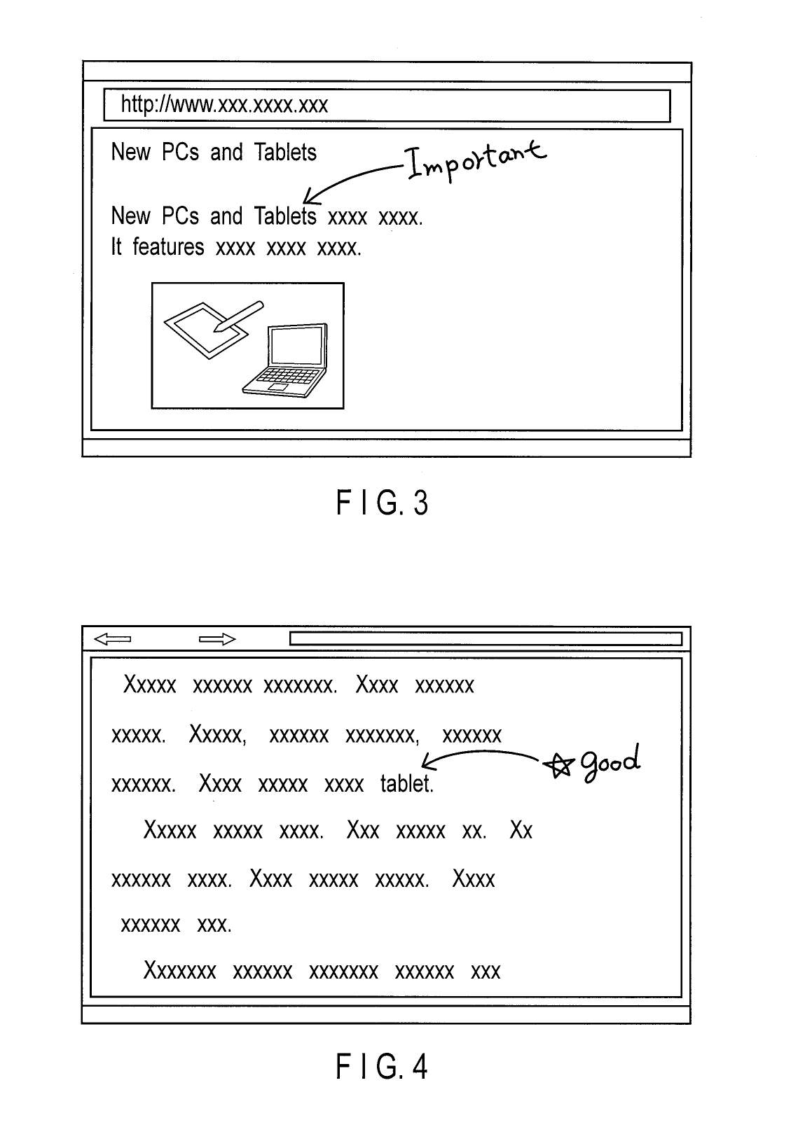

FIG. 3 illustrates an example of a handwritten annotation which is directly added to a Web page displayed on the touchscreen display 17.

A user can add a handwritten annotation (handwritten memo) at an arbitrary position on the Web page, namely, an arbitrary position on the screen by using the pen 100. In FIG. 3, it is assumed that a handwritten character string “Important” is added on the Web page by a handwriting input operation. Further, on this Web page, a handwritten arrow is also added.

The handwritten arrow is a handwritten object indicative of the association between the handwritten character string “Important” and a certain element in the Web page (here, the character string “Tablet” in the element). This element is a part of context information of the Web page.

In the present embodiment, as stated above, a handwritten object associated with a certain element is treated as a handwritten annotation (handwritten memo). For example, since the above-mentioned handwritten character string “Important” is associated with the element in the Web page (here, “Tablet” in the element) by the handwritten arrow, the handwritten character string “Important” is treated as a handwritten annotation (handwritten memo). Examples of handwritten objects that can be used as handwritten annotations include handwritten characters, handwritten graphics, handwritten marks, handwritten tables, or any combination of the above. The element with which the handwritten annotation is associated (context information part) will be referred to as an anchor element.

FIG. 4 illustrates an example of a handwritten annotation which is directly added to an electronic book displayed on the touchscreen display 17.

A user can add a handwritten annotation (handwritten memo) at an arbitrary position on a page of the electronic book, namely, an arbitrary position on the screen by using the pen 100. In FIG. 4, it is assumed that a handwritten star and a handwritten character string “good” are added on the page of the electronic book by a handwriting operation. Further, on this page of the electronic book, a handwritten arrow is also added. The handwritten arrow is a handwritten object indicative of the association between the handwritten object (namely, a set of the handwritten star and the handwritten character string “good”) and the anchor element in the electronic book (here, the character string “tablet”). Since the set of the handwritten star and the handwritten character string “good” is associated with an element in the electronic book (here, the character string “tablet”) by the handwritten arrow, the set of the handwritten star and the handwritten character string “good” is treated as a handwritten annotation (handwritten memo).

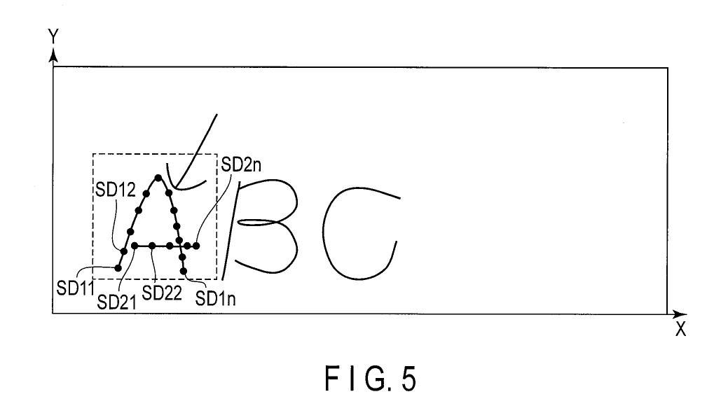

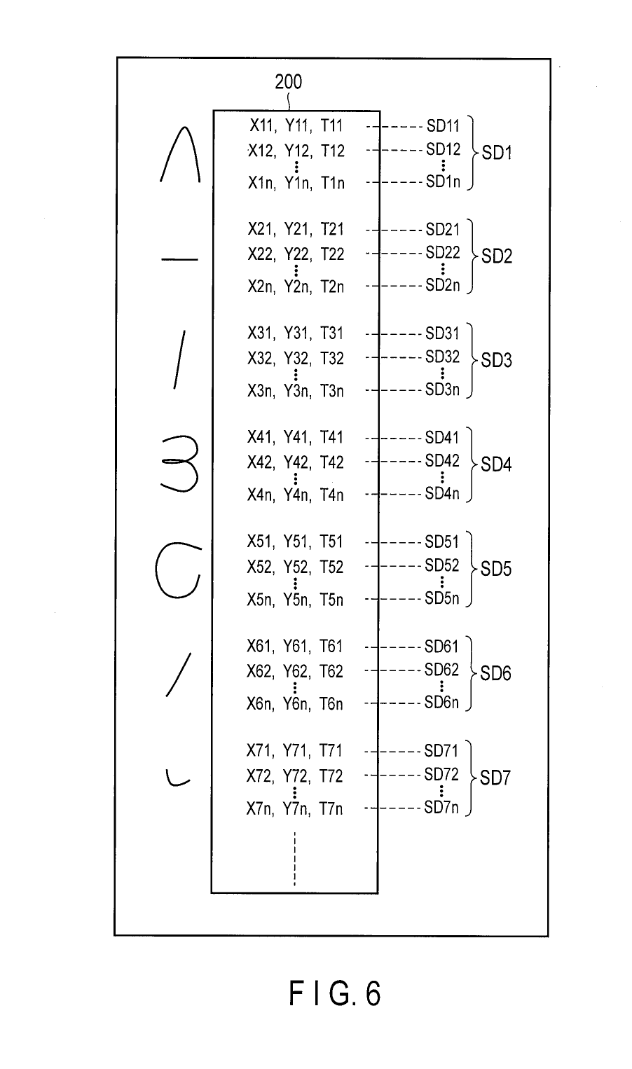

Next, with reference to FIGS. 5 and 6, a relationship between strokes (characters, graphics, marks, tables, etc.) handwritten by a user and handwritten data (time-series information) will be described. FIG. 5 illustrates an example of a handwritten object (handwritten character string) added on the touchscreen display 17 by using the pen 100 or the like.

In FIG. 5, it is assumed that a handwritten character string “ABC” is input by handwriting in the order of “A”, “B”, and “C”, and then a handwritten arrow is input by handwriting close to the handwritten character “A”.

The handwritten character “A” is represented by two strokes (a locus in the form of “A” and a locus in the form of “−”) which are handwritten by using the pen 100 or the like, that is, by two loci. The locus of the pen 100 in the form of “Λ” which is handwritten first is sampled in real time at regular time intervals, for example. In this way, time-series coordinates SD11, SD12, . . . SD1n of the “Λ” stroke are obtained. Similarly, the locus of the pen 100 in the form of “−” which is handwritten next is sampled in real time at regular time intervals, and time-series coordinates SD21, SD22, . . . SD2n of the “−” stroke are thereby obtained.

The handwritten character “B” is represented by two strokes which are handwritten by using the pen 100 or the like, that is, by two loci. The handwritten character “C” is represented by one stroke which is handwritten by using the pen 100 or the like, that is, by one locus. The handwritten arrow is represented by two strokes (a locus of the head of an arrow and a locus of the shaft) which are handwritten by using the pen 100 or the like, that is, by two loci.

FIG. 6 illustrates time-series information 200 corresponding to the handwritten object of FIG. 5. The time-series information 200 includes a plurality of items of stroke data SD1, SD2, . . . SD7. In the time-series information 200, these items of stroke data SD1, SD2, . . . SD7 are arranged in time series in the order of strokes, that is, in the order in which the strokes are handwritten.

In the time-series information 200, the first two items of stroke data SD1 and SD2 are indicative of the two strokes of the handwritten character “A”, respectively. The third and the fourth items of stroke data SD3 and SD4 are indicative of two strokes which constitute the handwritten character “B”, respectively. The fifth item of stroke data SD5 is indicative of one stroke which constitutes the handwritten character “C”. The sixth and the seventh items of stroke data SD6 and SD7 are indicative of the two strokes which constitute the handwritten arrow.

Each item of stroke data includes coordinate data series (time-series coordinates) corresponding to one stroke, namely, a plurality of coordinates corresponding to a plurality of points on the locus of one stroke. In each item of stroke data, the plurality of coordinates are arranged in time series in the order of strokes written. For example, with respect to the handwritten character “A”, stroke data SD1 includes the coordinate data series (time-series coordinates) corresponding to the points on the locus of the “Λ” stroke of the handwritten character “A”, namely, n items of coordinate data SD11, SD12, . . . SD1n. Stroke data SD2 includes coordinate data series corresponding to the points on the locus of the “−” stroke of the handwritten character “A”, namely, n items of coordinate data SD21, SD22, . . . SD2n. Further, the number of coordinate data may be different for each stroke data.

Each item of coordinate data is indicative of an X coordinate and a Y coordinate corresponding to a certain point in the associated locus. For example, coordinate data SD11 is indicative of the X coordinate (X11) and the Y coordinate (Y11) of the starting point of the “Λ” stroke. SD1n is indicative of the X coordinate (X1n) and the Y coordinate (Y1n) of the end point of the “Λ” stroke.

Further, each item of coordinate data may include time stamp information T representing the point of time when a point corresponding to the coordinates was handwritten. The point of time at which the point was handwritten may be either an absolute time (for example, year, month, day, hour, minute, and second) or a relative time with reference to a certain point of time. For example, it is possible to add the absolute time (for example, year, month, day, hour, minute, and second) at which a stroke began to be handwritten to each item of stroke data as time stamp information. Further, the relative time indicative of a difference from the absolute time may be added as time stamp information T to each item of coordinate data in the stroke data.

As can be seen, by using the time-series information including the time stamp information T added to each item of coordinate data, it is possible to represent the temporal relationship between strokes more accurately.

Moreover, information (Z) indicative of writing pressure may be added to each item of coordinate data.

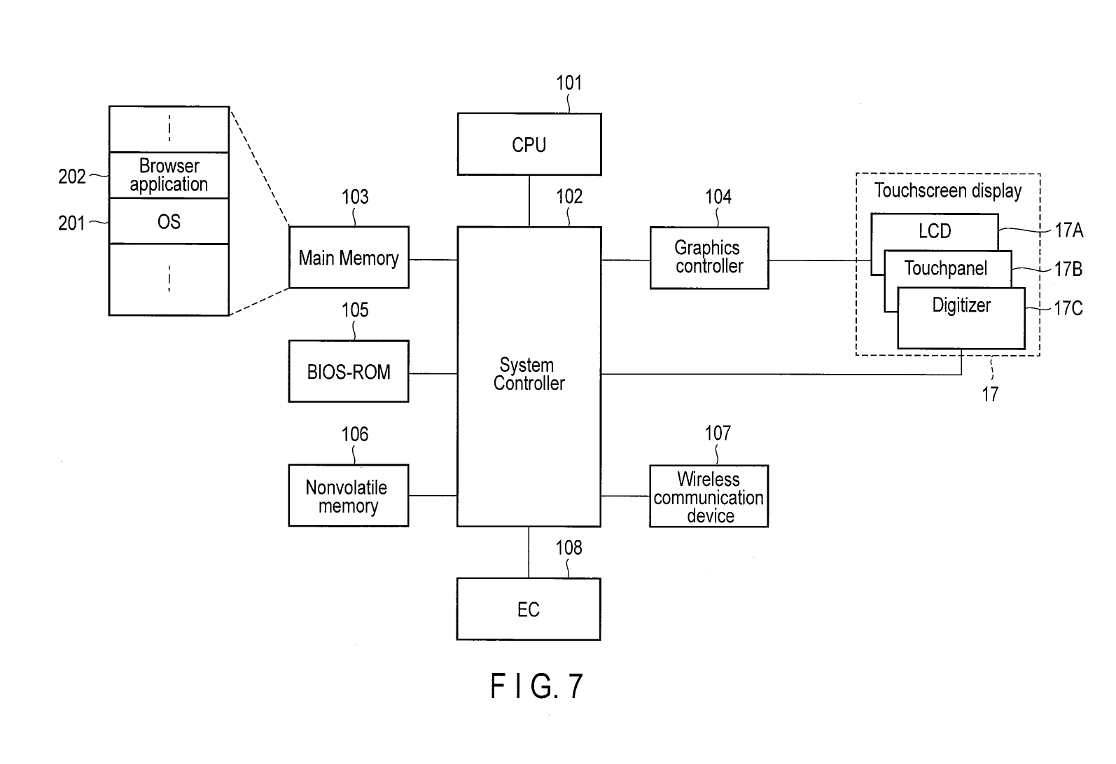

FIG. 7 is a diagram illustrating a system structure of the tablet computer 10.

As shown in FIG. 7, the tablet computer 10 comprises a CPU 101, a system controller 102, a main memory 103, a graphics controller 104, a BIOS-ROM 105, a storage device 106, a wireless communication device 107, an embedded controller (EC) 108, etc.

The CPU 101 is a processor configured to control the operation of various modules in the tablet computer 10. The CPU 101 executes various kinds of programs which are loaded into the main memory 103 from the storage device 106, such as a nonvolatile memory. The programs executed by the CPU 101 include an operating system (OS) 201 and various application programs. The application programs include a browser application program 202 or the like.

The browser application program 202 includes the function of acquiring data of a Web page from a Web server, the function of displaying the Web page on a screen, the function of adding a handwritten annotation on the Web page, and the function of reflowing the Web page in accordance with the screen size. A reflow is the function of changing a style (layout) of the Web page in accordance with the screen size (the window size of the browser application program 202), etc.

For example, a Web page is reflowed when the window size of the browser application program 202 is changed by a user, when a display mode of the tablet computer 10 is switched between a landscape mode and a portrait mode, or when the Web page is enlarged or reduced.

In the present embodiment, in the reflow processing of a Web page, not only the style (layout) of the Web page itself is changed, but also the position of a handwritten annotation associated with the anchor element in the Web page is automatically adjusted. In this case, the handwritten annotation is not simply moved together with the anchor element. The browser application program 202 moves the handwritten annotation such that a relative positional relationship between the anchor element and the handwritten annotation is differed before and after reflow.

Now, it is assumed that a handwritten annotation is displayed in a first area of a Web page before reflow, namely, when the Web page is displayed in a first style. A position of the first area relative to an anchor element, namely, a relative position of the first area with respect to the anchor element is a first relative position.

After reflow, namely, when the Web page is displayed in a second style different from the first style, a display position of the handwritten annotation is changed to a second area different from the first area. The second area is a part of the Web page of the second style. In the Web page of the second style, a relative position of the second area with respect to the anchor element is a second relative position different from the first relative position.

As can be seen, in the present embodiment, before and after reflow, a relative positional relationship between the anchor element and the handwritten annotation is not fixed. That is, the relative positional relationship is changed before and after reflow. By such a structure, it becomes possible to easily display the handwritten annotation to an area which does not overlap any element. The second area may be a part of a free area between adjacent elements in the Web page of the second style. Further, the second area may be a part of a margin area of the Web page of the second style.

In the reflow processing, the browser application program 202 can further display, on the Web page of the second style, additional information (for example, an arrow, a line, etc.) indicative of the association between the handwritten annotation which has been reflowed (rearranged) and the reflowed (rearranged) anchor element.

The additional information enables to present to a user that the handwritten annotation is associated with the anchor element even if the position of the second area in which the handwritten annotation is displayed is relatively far from the anchor element.

In addition, the CPU 101 executes a Basic Input/Output System (BIOS) stored in the BIOS-ROM 105. The BIOS is a program for controlling hardware.

The system controller 102 is a device for connecting between a local bus of the CPU 101 and various components. A memory controller for access controlling the main memory 103 is also built into the system controller 102. Further, the system controller 102 has the function of executing communication with the graphics controller 104 via a serial bus.

The graphics controller 104 is a display controller configured to control an LCD 17A to be used as a display monitor of the tablet computer 10. A display signal generated by the graphics controller 104 is sent to the LCD 17A. The LCD 17A displays a screen image based on the display signal. On an upper layer of the LCD 17A, a touchpanel 17B is arranged as a first sensor configured to detect a contact position of a finger on the screen. Further, on a lower layer of the LCD 17A, a digitizer 17C is arranged as a second sensor configured to detect a contact position of the pen 100 on the screen. The touchpanel 17B is a capacitive pointing device for inputting data on the screen of the LCD 17A. A contact position on the screen touched by a finger and movement of the contact position and the like are detected by the touchpanel 17B. The digitizer 17C is an electromagnetic induction-type pointing device for inputting data on the screen of the LCD 17A. A contact position on the screen touched by the pen 100 and movement of the contact position and the like are detected by the digitizer 17C.

The OS 201 issues an input event which indicates that a finger has touched the screen and the contact position of the finger in cooperation with a driver program for controlling the touchpanel 17B. In addition, the OS 201 issues an input event which indicates that the pen 100 has touched the screen and the contact position of the pen 100 in cooperation with a driver program for controlling the digitizer 17C.

The wireless communication device 107 is a device configured to execute wireless communication such as wireless LAN or 3G mobile communication.

The EC 108 is a one-chip microcomputer including an embedded controller for power management. The EC 108 has the function of powering on or off the tablet computer 10 in accordance with an operation of a power button by a user.

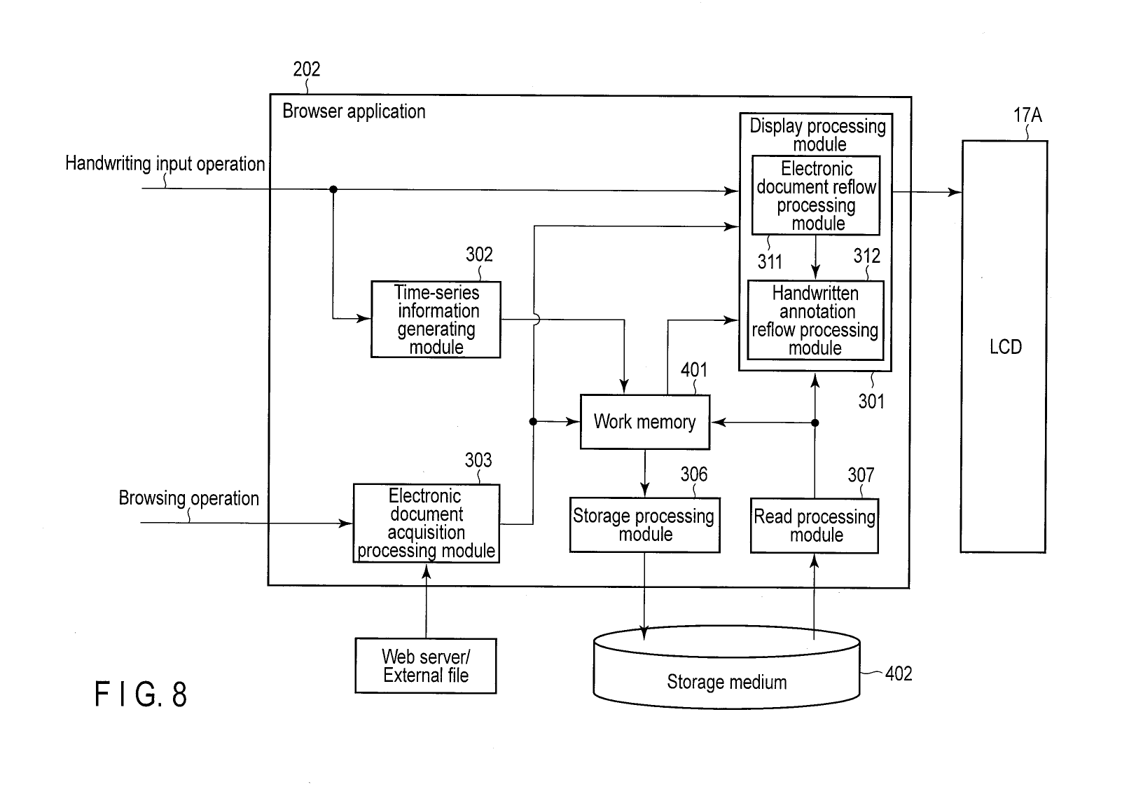

Next, with reference to FIG. 8, a function structure of the browser application program 202 will be described.

The browser application program 202 includes a display processing module 301, a time-series information generating module 302, an electronic document acquisition processing module 303, a storage processing module 306, a read processing module 307, etc.

The electronic document acquisition processing module 303 acquires data of an electronic document (Web page), such as an HTML file, from a Web server or an external file. The display processing module 301 displays the Web page on the screen of the LCD 17A.

The display processing module 301 and the time-series information generating module 302 receive an event of “touch”, “move (slide)”, or “release” generated by the digitizer 17C, thereby detecting a handwriting input operation. The “touch” event includes coordinates of the contact position of the pen 100. The “move (slide)” event includes the coordinates of the contact position of the moved pen 100. Therefore, the display processing module 301 and the time-series information generating module 302 can receive coordinate series corresponding to the loci of movement of the contact positions from the digitizer 17C.

Similarly, the display processing module 301 and the time-series information generating module 302 can receive an event of “touch”, “move (slide)”, or “release” generated by the touchpanel 17B. The “touch” event includes coordinates of the contact position of a finger. The “move (slide)” event includes the coordinates of the contact position of the moved finger. Therefore, the display processing module 301 and the time-series information generating module 302 can receive coordinate series corresponding to the loci of movement of the contact positions from the touchpanel 17B.

The display processing module 301 can display a handwritten stroke on the screen, namely, on the Web page, based on a group of events input from the digitizer 17C in accordance with the movement of the pen 100 on the screen. That is, a line corresponding to the locus of the movement of the pen 100 on the screen is drawn on the Web page. Further, the display processing module 301 can detect a gesture of a finger on the screen based on the group of events input from the touchpanel 17B in accordance with the movement of the finger on the screen. When a gesture of a finger on the screen is detected, the display processing module 301 can execute processing corresponding to the detected gesture.

The display processing module 301 comprises an electronic document reflow processing module 311 and a handwritten annotation reflow processing module 312 in order to reflow both the Web page and the handwritten annotation (the handwritten stroke associated with a certain element) on the Web page.

The electronic document reflow processing module 311 and the handwritten annotation reflow processing module 312 function as a processor configured to reflow an electronic document including a handwritten annotation and change the style (layout) of the electronic document including the handwritten annotation.

The electronic document reflow processing module 311 reflows a Web page on the screen and displays the Web page in a new style when a reflow factor is detected, for example, when the window size of the browser application program 202 is changed by a user, when a display mode of the tablet computer 10 is switched between a landscape mode and a portrait mode, or when a gesture for enlarging or reducing the Web page (a pinch-out gesture or a pinch-in gesture) is detected. In this case, the electronic document reflow processing module 311 determines a size of each of a plurality of elements that constitute the Web page, and positions where those elements should be displayed on the screen (the positions in the window of the browser application program 202).

The handwritten annotation reflow processing module 312 reflows the handwritten annotation such that it adapts to the Web page of a new style. Now, in a Web page before reflow, it is assumed that a handwritten annotation and an anchor element have a certain relative positional relationship. That is, it is assumed that the handwritten annotation is displayed in a first area on a window, and a relative position of the first area with respect to the anchor element is a first relative position.

The handwritten annotation reflow processing module 312 changes the display position of the handwritten annotation from the first area to a second area in the Web page of the new style. In this case, a relative position of the second area with respect to the anchor element in the Web page of the new style is a second relative position different from the first relative position.

Conventional reflow technology is mostly intended to move a handwritten annotation while maintaining a relative positional relationship between the anchor element and the handwritten annotation. For example, an annotation displayed in a certain margin area of an electronic document is slightly moved within this margin area in accordance with the movement of the anchor element. In this case, before and after reflow, the relative positional relationship between the anchor element and the handwritten annotation is the same. However, with such a method, it may be difficult to display the handwritten annotation when a position of the margin area in the electronic document has changed by the reflow or when the space of the margin area in the electronic document has been reduced by the reflow.

In the present embodiment, before and after reflow, a display position of the handwritten annotation is changed from the first area to the second are such that the relative positional relationship between the anchor element and the handwritten annotation is changed. Therefore, since the display position of the handwritten annotation can be changed to another margin area different from the original margin area where the handwritten annotation was displayed before reflow, or some other free area, it is possible to efficiently reflow (rearrange) the handwritten annotation such that the handwritten annotation does not overlap any element in the Web page of the new style.

Further, the handwritten annotation reflow processing module 312 can display, on the Web page of the new style, additional information (an arrow, a line, etc.) for representing the association between the handwritten annotation and the anchor element. In this way, even if a handwritten annotation is displayed at a position relatively far from the anchor element in the Web page of the new style, it is possible to present the association between those handwritten annotation and the anchor element to a user.

The time-series information generating module 302 receives the aforementioned coordinate series (the group of input events) output from the digitizer 17C, and generates the time-series information having the structure as described in detail with reference to FIG. 6 based on the coordinate series. The time-series information generating module 302 temporary stores the generated time-series information in a work memory 401.

The storage processing module 306 stores the Web page including a handwritten annotation, etc., on a storage medium 402. The storage medium 402 may be a storage device in the tablet computer 10 or a storage device of a server computer 2, for example.

The read processing module 307 reads the Web page including the handwritten annotation, etc., from the storage medium 402. The Web page which has been read is transmitted to the display processing module 301. The display processing module 301 displays the Web page including the handwritten annotation, etc., on the screen.

As described above, a reflowable electronic document is not limited to a Web page, but can also be applied to various other reflowable electronic documents, such as an electronic book.

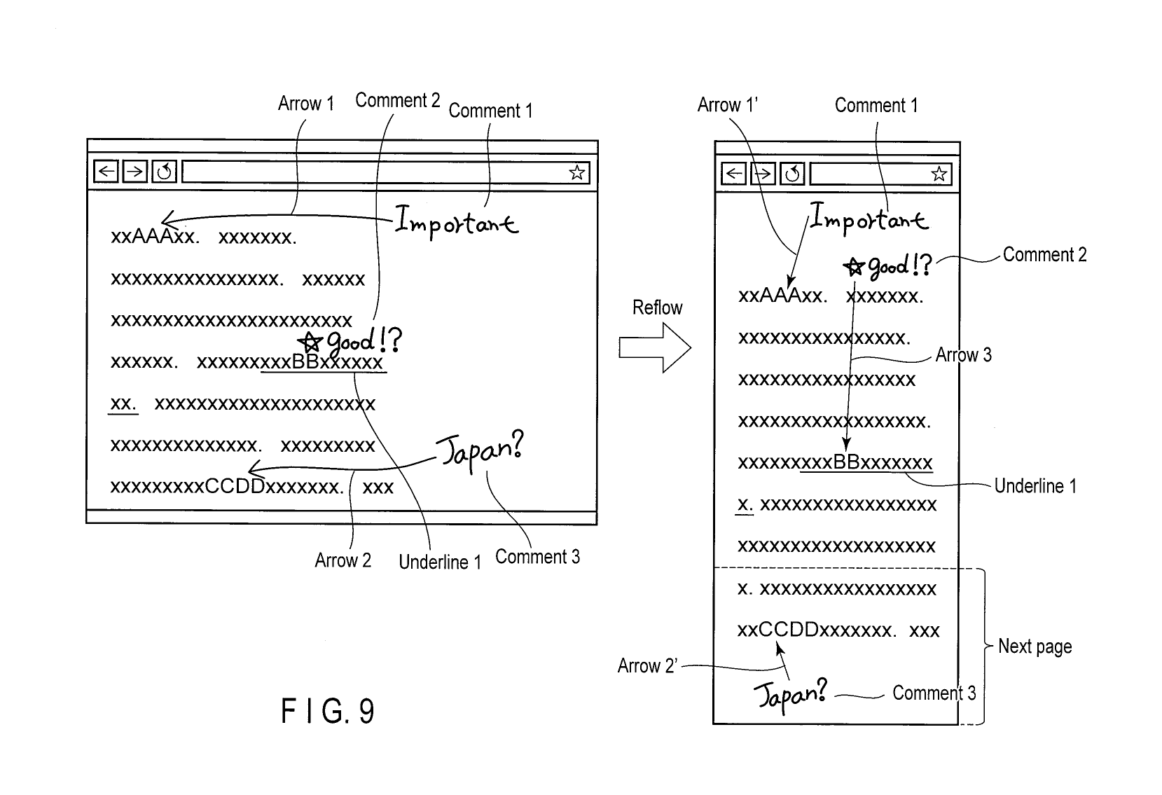

FIG. 9 illustrates an example of a relationship between display positions of handwritten annotations on an electronic document before reflow and display positions of the handwritten annotations on an electronic document after reflow. Here, it is assumed that the electronic document is an electronic book.

The left side of FIG. 9 illustrates a screen (window) on which an electronic book before reflow is displayed, and the right side of FIG. 9 illustrates a screen (window) on which an electronic book after reflow is displayed.

Now it is assumed that several handwritten annotations (Comment 1, Comment 2, and Comment 3) are added to context information (here, a text) of a certain paragraph of the electronic book before reflow. As shown in the left side of FIG. 9, when there is a relatively large margin area at the right side part on the page of the electronic book, a user can add handwritten annotations (handwritten comments) on this margin area by the handwriting operation.

Comment 1 is composed of a handwritten character string (here, “Important”). Comment 1 is associated with a certain element in the electronic book (here, the character string “AAA”) by handwritten Arrow 1.

Comment 2 is composed of a handwritten mark (here, a star) and a handwritten character string (here, “good!?”). Comment 2 is associated with an underlined element (here, the character string “ . . . BB . . . ”). That is, in the present embodiment, one or more handwritten strokes near an underlined element are recognized as a handwritten annotation associated with the underlined element. The underline can easily be drawn by a handwriting input operation using the pen 100. The underline may be a handwritten stroke (handwritten line) or a line drawn by using an html underline code. Here, an example using an underline for identifying the element associated with the handwritten annotation has been described. Instead of underlines, a double underline or any symbol or the like may be used to identify an element associated with the handwritten annotation.

Comment 3 is composed of a handwritten character string (here “Japan?”). Comment 3 is associated with a certain element in the electronic book (here, the character string “CCDD”).

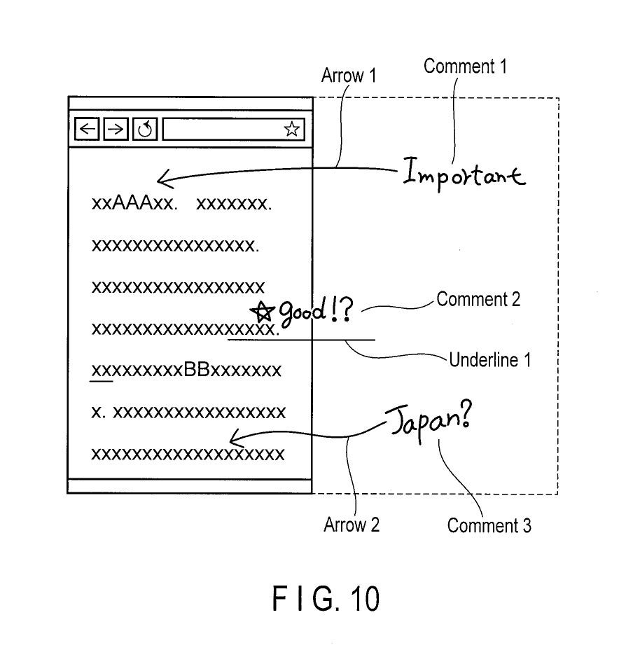

Here, when the size of a window is changed, for example, the electronic book is reflowed, but the handwritten annotations, the handwritten arrows, and the underline are not rearranged (the state of FIG. 10). When a window is reduced in size in a lateral direction by the change of the window size, an area in which the handwritten annotations were added (here, the right side margin area on the page of the electronic book) may sometimes disappear greatly, as shown in FIG. 10. For this reason, unless the handwritten annotations are moved, the handwritten annotations will be out of the window and cannot be displayed.

Thus, in the present embodiment, reflow processing of moving the handwritten annotations and the underline to positions which do not overlap any of the elements is executed. If there is a free area which does not display any element (context information) on the current page of the electronic book (i.e., a free area between adjacent paragraphs, a margin area of the page), the handwritten annotations may be moved to this free area. If there is no sufficient free area, the electronic book may be reflowed so that a free area between adjacent paragraphs is increased or a margin area of a certain portion of the page is increased, for example.

In the right side of FIG. 9, the case assumed is that the handwritten annotations are displayed using margin areas located on the top and the bottom of the page of the electronic book. As described above, the margin area may be secured by reflowing the electronic book such that a free area can be set in at least the top or the bottom of a paragraph.

As shown on the right side of FIG. 9, the display position of Comment 1 is moved from the margin area located near the right side of the page of the electronic book to the margin area located near the top side which is orthogonal to this right side, for example.

Further, handwritten Arrow 1 is converted (reshaped) to arrow-shaped graphic data to facilitate the rearrangement of the handwritten Arrow 1. That is, the arrow-shaped graphic data, namely, Arrow 1′, is displayed in place of handwritten Arrow 1. Arrow 1′ is used as the above-mentioned additional information for representing the association between Comment 1 and the character string “AAA”. Arrow 1′ is displayed to extend from the display position of Comment 1 to the display position of the character string “AAA”. Alternatively, instead of displaying Arrow 1′, a line for representing the association between Comment 1 and the character string “AAA” can be displayed. As this line, a line extending between Comment 1 and the character string “AAA” (a straight line or a curved line) may be used.

Comment 2 is also moved to a margin area at the top of the page of the electronic book, for example. Further, Arrow 3 for representing the relationship between Comment 2 and the character string “ . . . BB . . . ” is also displayed as additional information. Instead of Arrow 3, a line for representing the association between Comment 2 and the character string “ . . . BB . . . ” may be displayed.

Comment 3 is moved to a margin area near the bottom of the next page of the electronic book, for example. Further, instead of handwritten Arrow 2, Arrow 2′ for representing the association between Comment 3 and the character string “CCDD” is displayed. Instead of Arrow 2′, a line for representing the association between Comment 3 and the character string “CCDD” may be displayed.

Each of the display positions of Comments 1, 2, and 3 may be determined such that the shafts (line segments) of Arrow 1′, Arrow 2′, and Arrow 3 do not cross each other.

As can be seen, in the present embodiment, a relative position of the handwritten annotation with respect to the anchor element is changed between before reflow and after reflow. Therefore, even if a layout of an electronic document has changed greatly by a reflow of the electronic document, or a margin area which displayed the handwritten annotation disappeared by the reflow of the electronic document, it is possible to easily display the handwritten annotation to a different margin area.

Further, in the present embodiment, in the reflow processing, an arrow (line) for associating the anchor element and the handwritten annotation is added. Therefore, in an electronic document reflowed to a new style, even if the anchor element and the handwritten annotation are positioned relatively far from each other, it is possible to present the association between the anchor element and the handwritten annotation to a user.

A display mode of an electronic book can be switched between a mode of displaying a text in vertical writing and a mode of displaying the text in horizontal writing. Since the style of the electronic book is changed by the switching of the display mode, an operation for switching the display mode can be treated as one form of a reflow.

If there exists a handwritten stroke (a handwritten character, a handwritten mark, handwritten graphics, etc.) which is not associated with any element in an electronic document before reflow, this handwritten stroke does not have to be reflowed (rearranged). Alternatively, after rearranging all of the handwritten annotations in a certain margin area, the handwritten stroke not associated with any element may be displayed in an unused area of the margin area.

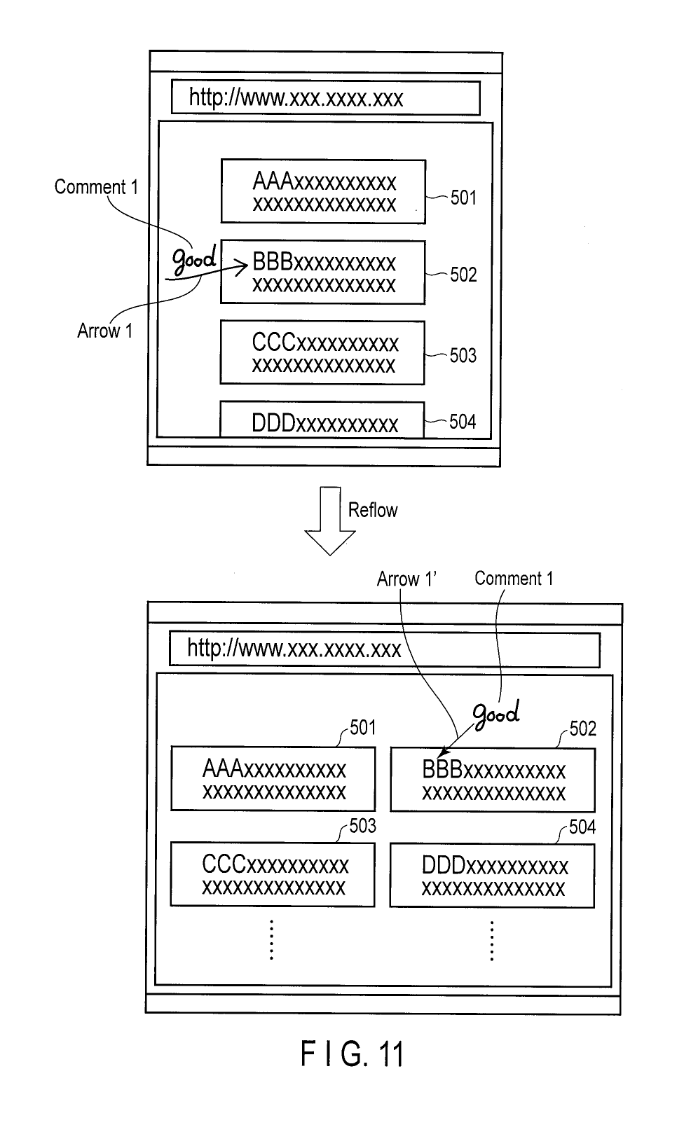

FIG. 11 illustrates another example of a relationship between a display position of a handwritten annotation on an electronic document before reflow and a display position of the handwritten annotation on an electronic document after reflow. Here, it is assumed that the electronic document is a Web page.

The upper part of FIG. 11 illustrates a screen (window) on which a Web page before reflow is displayed, and the lower part of FIG. 11 illustrates a screen (window) on which a Web page after reflow is displayed.

Now, it is assumed that the Web page is composed of context information parts (elements) 501, 502, 503, 504, . . . . These context information parts 501, 502, 503, 504, . . . correspond to a plurality of hierarchical elements described in the HTML file, respectively. In other words, these context information parts 501, 502, 503, 504, . . . correspond to the elements in the Web page, respectively.

As shown in the upper part of FIG. 11, before reflow, context information parts 501, 502, 503, and 504 are arranged vertically in a line. Comment 1 is composed of a handwritten character string (here, “good”). Comment 1 is associated with context information part 502 by handwritten Arrow 1. More specifically, Comment 1 is associated with a certain portion (here, character string “BBB”) in context information part 502 by handwritten Arrow 1.

Here, when the size of a window is changed, the Web page is reflowed, and the style of the Web page is changed. For example, when the window is widened by the change of the window size, as shown in the lower part of FIG. 11, there are cases where context information parts 501, 502, 503, 504, . . . are rearranged such that context information parts 501, 502, 503, 504, . . . are arranged vertically in two lines.

If Comment 1 is simply moved together with context information part 502, namely, if Comment 1 is moved to a position corresponding to context information part 502 while maintaining the relative positional relationship between Comment 1 and context information part 502, there is a possibility that Comment 1 will overlap context information part 501. In the present embodiment, as described above, in reflowing, a relative position of Comment 1 with respect to context information part 502 (for example, character string “BBB” in context information part 502) is changed, and Comment 1 is displayed in a free area of the Web page where no context information part exists.

As shown in the lower part of FIG. 11, Comment 1 is displayed in a free area in the upper part of context information part 502, for example. Further, handwritten Arrow 1 is converted (reshaped) to arrow-shaped graphic data (Arrow 1′), and the Arrow 1′ for representing the association between Comment 1 and context information part 502 (character string “BBB”) is displayed in place of handwritten Arrow 1. Arrow 1′ extends to a display position of the character string “BBB” from the display position of Comment 1. Alternatively, instead of displaying Arrow 1′, a line for representing the association between Comment 1 and the character string “BBB” may be displayed. As this line, a line extending between Comment 1 and the character string “BBB” may be used.

Further, it is possible to reflow the Web page such that an area between context information part 502 and context information part 504 is increased, namely, an area between adjacent elements is increased. By doing so, it is possible to display Comment 1 in an area (free area) extended between context information part 502 and context information part 504.

In addition, additional information for representing the association between Comment 1 and context information part 502 (character string “BBB”) is not limited to the aforementioned arrow and line. For example, a mark, a symbol, graphics, or the like, of the same shape may be added in both the vicinity of Comment 1 and the vicinity of context information part 502 (character string “BBB”).

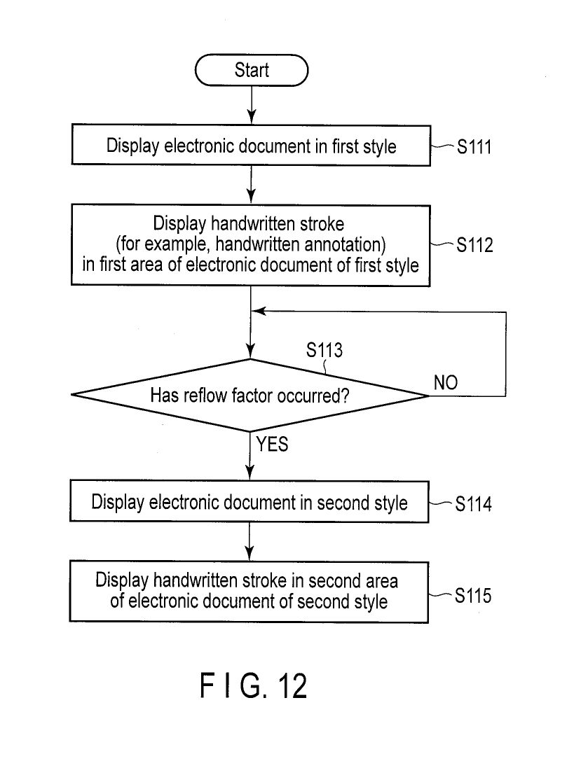

A flowchart of FIG. 12 illustrates the procedure of display processing executed by the browser application program 202.

The display processing module 301 of the browser application program 202 displays an electronic document (a Web page or an electronic book) in a first style on a screen of the touchscreen display 17 (step S111). The first style is a style (layout) of an electronic document which adapts to the current screen size. When a handwriting input operation is performed on the screen of the touchscreen display 17, the display processing module 301 displays on the electronic document at least one stroke input by handwriting (step S112). Further, if an arrow or an underline or the like for associating the at least one stroke (handwritten stroke) and a certain element (anchor element) in the electronic document is handwritten on the electronic document, the at least one stroke (handwritten stroke) is treated as a handwritten annotation. By steps S111 and S112, an electronic document including the handwritten stroke (handwritten annotation) is displayed on the screen. Further, based on an arbitrary electronic document including a handwritten annotation, which is read from a storage medium, the display processing module 301 can display the electronic document including the handwritten stroke (handwritten annotation) on the screen.

It is assumed that the electronic document is displayed in the first style, and a handwritten stroke is displayed in a first area in the electronic document of the first style. A relative position of the first area with respect to an element with which the handwritten stroke is associated is assumed to be a first relative position.

The electronic document reflow processing module 311 detects presence or absence of occurrence of a reflow factor (step S113). If occurrence of the reflow factor (for example, a change or the like of the screen size) is detected (YES in step S113), the electronic document reflow processing module 311 reflows the electronic document so that it adapts to the changed screen size (the changed window size of the browser application program 202) (step S114). In step S114, the electronic document reflow processing module 311 displays the electronic document in a second style different from the first style on the screen of the touchscreen display 17 (step S114). The second style is a style (layout) of the electronic document which adapts to the changed screen size.

Further, the handwritten annotation reflow processing module 312 changes a display position of the handwritten stroke from the first area to a second area of the electronic document of the second style by using a free area and a margin area of the electronic document reflowed to the second style, for example (step S115). A relative position of the second area with respect to the anchor element is a second relative position different from the above-mentioned first relative position. In step S115, the handwritten annotation reflow processing module 312 performs the processing of detecting a free area and a margin area of the electronic document of the second style, and a part of the detected free area or a part of the detected margin area may be determined as the second area in which the handwritten stroke should be displayed.

Further, if the size of a free area or the size of a margin area in the electronic document is too small, the handwritten annotation reflow processing module 312 may reflow the electronic document so that a sufficient free space or margin area can be secured in cooperation with the electronic document reflow processing module 311.

In step S115, the handwritten annotation reflow processing module 312 further displays additional information for representing the association between the anchor element and the handwritten stroke (handwritten annotation) on the electronic document of the second style.

As has been explained, in the present embodiment, a display position of a handwritten stroke is changed such that a relative positional relationship between the anchor element and the handwritten stroke is changed before and after reflow. Accordingly, for example, since a display position of a handwritten stroke can be changed to another margin area different from the original margin area where the handwritten stroke was displayed before reflow, or to some other space area, it is possible to efficiently reflow (rearrange) the handwritten stroke such that it does not overlap any element in the electronic document of a new style. Accordingly, it is possible to display the electronic document including the handwritten stroke in an easy-to-see manner.

Since various types of processing of the present embodiment can be realized by a computer program, it is possible to easily realize an advantage similar to that of the present embodiment by simply installing a computer program on an ordinary computer by way of a computer-readable storage medium having stored thereon the computer program, and executing this computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display processor configured to display an electronic document in a first style, the electronic document comprising a handwritten stroke associated with a first element of the electronic document, the handwritten stroke displayed in a first area of the electronic document of the first style, wherein the first area is in a first relative position with respect to the first element; and
a processor configured to display the electronic document in a second style different from the first style, and to change a display position of the handwritten stroke from the first area to a second area in the electronic document of the second style,
wherein a second relative position of the second area with respect to the first element in the electronic document of the second style is different from the first relative position of the first area with respect to the first element in the electronic document of the first style.

2. The electronic device of claim 1, wherein the processor is further configured to display additional information on the electronic document of the second style, the additional information indicative of a relationship between the first element and the handwritten stroke.

3. The electronic device of claim 2, wherein the additional information comprises a line extending between the handwritten stroke and the first element.

4. The electronic device of claim 2, wherein the additional information comprises an arrow extending toward the first element from the handwritten stroke.

5. The electronic device of claim 1, wherein the second area is a part of a free area between adjacent elements in the electronic document of the second style.

6. The electronic device of claim 1, wherein the second area is a part of a margin area in the electronic document of the second style.

7. A method of processing an electronic document, the method comprising:
displaying the electronic document in a first style, the electronic document comprising a handwritten stroke associated with a first element of the electronic document, the handwritten stroke displayed in a first area of the electronic document of the first style, wherein the first area is in a first relative position with respect to the first element;
displaying the electronic document in a second style different from the first style; and
changing a display position of the handwritten stroke from the first area to a second area in the electronic document of the second style,
wherein a second relative position of the second area with respect to the first element in the electronic document of the second style is different from the first relative position of the first area with respect to the first element in the electronic document of the first style.

8. The method of claim 7, further comprising displaying additional information on the electronic document of the second style, the additional information indicative of a relationship between the first element and the handwritten stroke.

9. The method of claim 8, wherein the additional information comprises a line extending between the handwritten stroke and the first element.

10. The method of claim 8, wherein the additional information comprises an arrow extending toward the first element from the handwritten stroke.

11. The method of claim 7, wherein the second area is a part of a free area between adjacent elements in the electronic document of the second style.

12. The method of claim 7, wherein the second area is a part of a margin area in the electronic document of the second style.

13. A computer-readable, non-transitory storage medium having stored thereon a computer program which is executable by a computer, the computer program controlling the computer to execute functions of:
displaying an electronic document in a first style, the electronic document comprising a handwritten stroke associated with a first element of the electronic document, the handwritten stroke displayed in a first area of the electronic document of the first style, wherein the first area is in a first relative position with respect to the first element;
displaying the electronic document in a second style different from the first style; and
changing a display position of the handwritten stroke from the first area to a second area in the electronic document of the second style,
wherein a second relative position of the second area with respect to the first element in the electronic document of the second style is different from the first relative position of the first area with respect to the first element in the electronic document of the first style.

14. The storage medium of claim 13, wherein the computer program further controls the computer to execute function of displaying additional information on the electronic document of the second style, the additional information indicative of a relationship between the first element and the handwritten stroke.

15. The storage medium of claim 14, wherein the additional information comprises a line extending between the handwritten stroke and the first element.

16. The storage medium of claim 14, wherein the additional information comprises an arrow extending toward the first element from the handwritten stroke.

17. The storage medium of claim 13, wherein the second area is a part of a free area between adjacent elements in the electronic document of the second style.

18. The storage medium of claim 13, wherein the second area is a part of a margin area in the electronic document of the second style.
